(19) United States
(12) Patent Application Publication
(10) Pub. No.: US 2010/0051637 A1
(43) Pub. Date: Mar. 4, 2010

(54) WIRELESS PARALLEL DISPENSING SYSTEM

(76) Inventor: Hsiu-Hung Shu, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 12/203,401

(22) Filed: Sep. 3, 2008

(51) Int. Cl. G07F 11/00; B67D 5/08; A47F 1/00

(52) U.S. Cl. 221/9; 222/52; 221/96

(57) ABSTRACT

A wireless parallel dispensing system includes an automatic soap dispenser, which comprises a CPU, an infrared sensor, a motor drive, a RF transmitter and a transmitting antenna and which transmits a RF signal when dispensing a liquid soap; an automatic perfume dispenser or an automatic tissue dispenser, which has built therein a RF receiver and a receiving antenna for receiving the RF signal from the automatic soap dispenser and which automatically dispenses a perfume or tissue each time it receives the RF signal from the automatic soap dispenser.

### BACKGROUND OF THE INVENTION

(a) Field of the Invention

The present invention relates to a dispensing system and more particularly to a wireless parallel dispensing system for use in a toilet to automatically dispense a liquid soap and a perfume or tissue at the same time.

(b) Description of the Prior Art

A public toilet booth generally provides an automatic soap dispenser, a hand dryer and a tissue dispenser around the sink, and one or more automatic perfume dispensers at suitable locations. When a user reaches his or her hands to the automatic soap dispenser, a sensor (for example, infrared sensor) in the automatic soap dispenser is induced to dispense a liquid soap dispensing motor to dispense a liquid soap. A hand dryer for use in a public toilet booth outputs hot air for drying the user's hands via the control of a sensor. However, a regular tissue dispenser for use in a public toilet booth must be operated manually. In a public toilet booth, the automatic soap dispenser, the hand dryer and the tissue dispenser are independent designs for operating separately. Further, an automatic perfume dispenser uses a timer to control the frequency of the dispensing of perfume. However, the frequency of use of automatic perfume dispenser is not all the same throughout a day. For example, people may use the toilet more frequently while off-duty or during other particular time periods. However, a conventional automatic perfume dispenser cannot automatically adjust its perfume dispensing time interval according to the frequency of use of the toilet to effectively maintain its sanitary condition.

### SUMMARY OF THE INVENTION

The present invention has been accomplished under the circumstances in view. It is one object of the present invention to provide a wireless parallel dispensing system, which employs wireless radio frequency signals between an automatic soap dispenser and an automatic perfume or tissue dispenser so that the automatic perfume or tissue dispenser automatically dispenses a perfume or tissue each time the automatic soap dispenser dispenses a liquid soap, for cleaning and sanitation.

To achieve this and other objects of the present invention, the wireless parallel dispensing system comprises an automatic soap dispenser and an automatic perfume dispenser or tissue dispenser. The automatic soap dispenser has built therein a RF transmitter and a transmitting antenna. The automatic perfume or tissue dispenser has built therein a RF receiver and a receiving antenna. When dispensing a liquid soap, the automatic soap dispenser transmits a RF signal via the RF transmitter and the transmitting antenna to the RF receiver and receiving antenna of the automatic perfume dispenser or tissue dispenser. Upon receipt of the RF signal, the automatic perfume dispenser or tissue dispenser automatically dispenses a certain amount of perfume or tissue.

### BRIEF DESCRIPTION OF THE DRAWINGS

FIG. 1 is a schematic drawing of a wireless parallel dispensing system according to the present invention.

FIG. 2 is a circuit block diagram of the control module of the automatic soap dispenser of the wireless parallel dispensing system in accordance with the present invention.

FIG. 3 is a circuit block diagram of the control module of the automatic perfume dispenser of the wireless parallel dispensing system in accordance with the present invention.

FIG. 4 is a circuit block diagram of the control module of the automatic tissue dispenser of the wireless parallel dispensing system in accordance with the present invention.

### DETAILED DESCRIPTION OF THE PREFERRED EMBODIMENTS

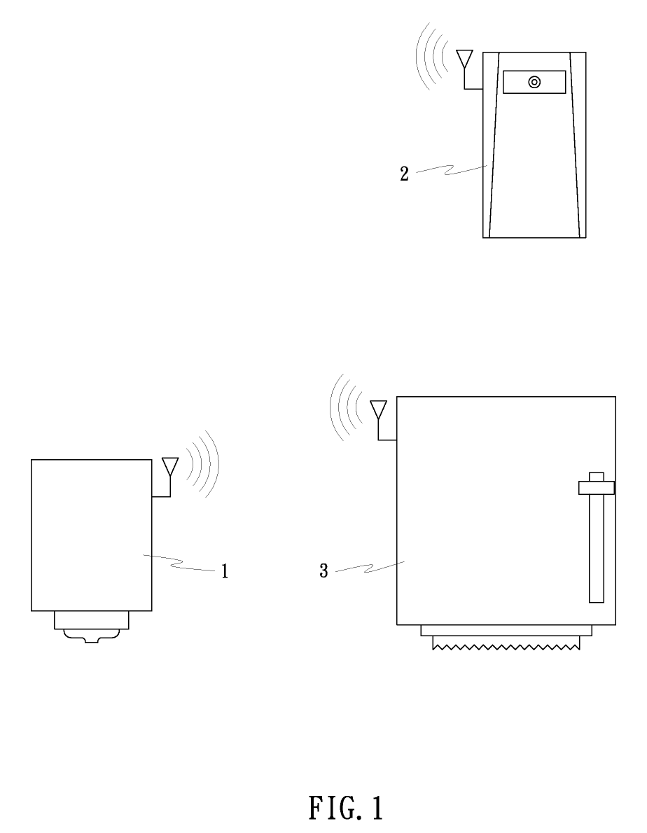

As illustrated in FIG. 1, a wireless parallel dispensing system in accordance with the present invention comprises an automatic soap dispenser 1 and an automatic perfume dispenser 2 and/or an automatic tissue dispenser 3.

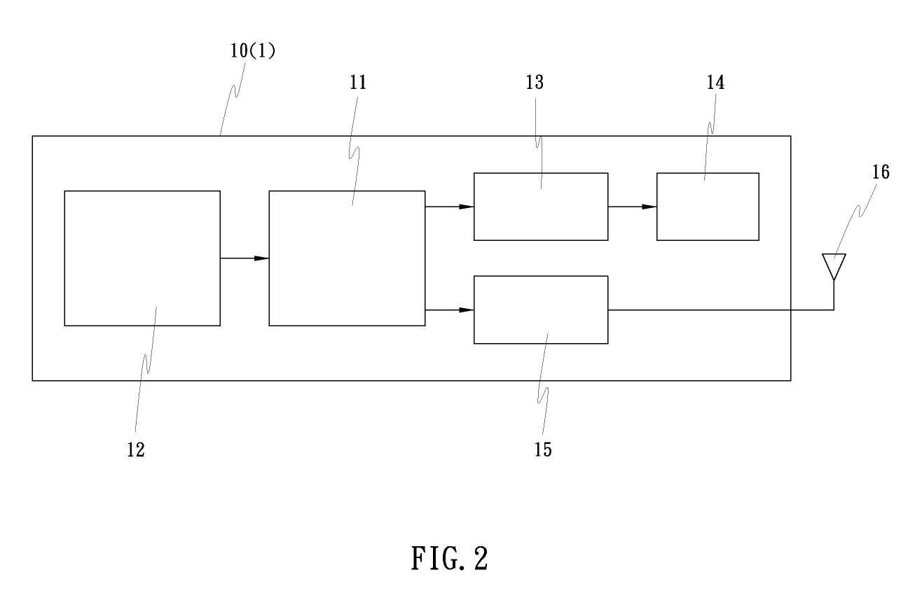

The automatic soap dispenser 1, as shown in FIG. 2, may be made in any of a variety of shapes, structures or types, having installed therein a control module 10. In addition to a CPU (central processing unit) 11, an infrared sensor 12 and a motor drive 13 like the structure of a conventional control module for automatic soap dispenser. The control module 10 of the automatic soap dispenser 1 further comprises a RF transmitter 15 and a transmitting antenna 16. The RF transmitter 15 is electrically connected to the CPU 11. The transmitting antenna 16 is electrically connected to the radio transmitter 15. The wireless parallel dispensing system is configured in such a manner that when the control module 10 of the automatic soap dispenser 1 (the CPU 11) starts the motor drive 13 to dispense a liquid soap 14, the CPU 11 synchronously controls the RF transmitter 15 and the transmitting antenna 16 to transmit a RF signal at the frequency band of 315˜433 MHz.

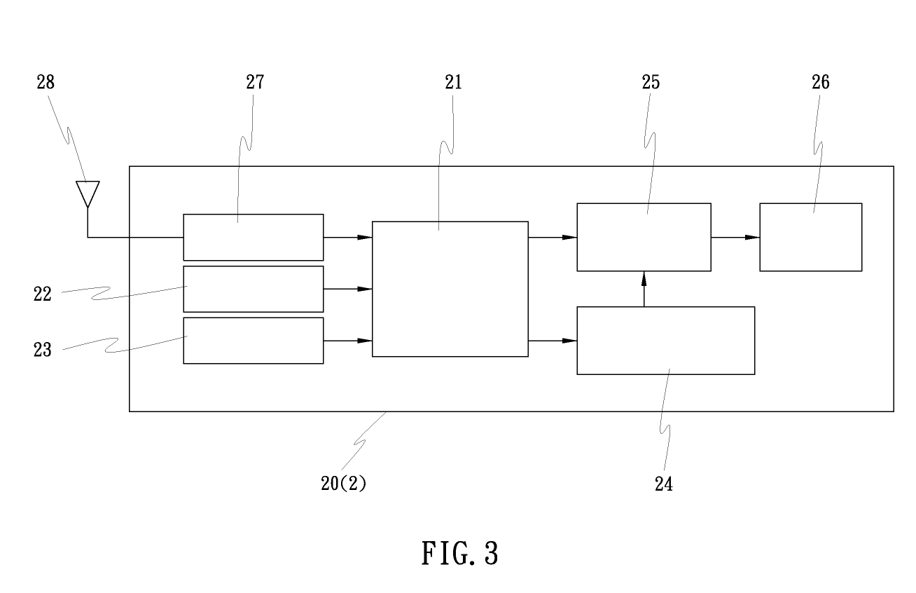

The automatic perfume dispenser 2, as shown in FIG. 3, is controllable to dispense a perfume. The automatic perfume dispenser 2 may be made in any of a variety of shapes, structures or types, having installed therein a control module 20. The control module 20 comprises a CPU (central processing unit) 21, a light sensor 22, a timer 23, a duty cycle setter 24 and a motor drive 25, and is adapted for dispensing a certain amount of perfume 26 periodically at a predetermined time interval per the control of the light sensor 22 and the timer 23. The control module 20 further comprises a RF receiver 27 and a receiving antenna 28. The RF receiver 27 is electrically connected to the CPU 21. The receiving antenna 28 is electrically connected to the RF receiver 27. When the RF receiver 27 receives a RF signal from the automatic soap dispenser 1 through the receiving antenna 28, the CPU 21 drives the motor drive 25 to dispense the perfume 26.

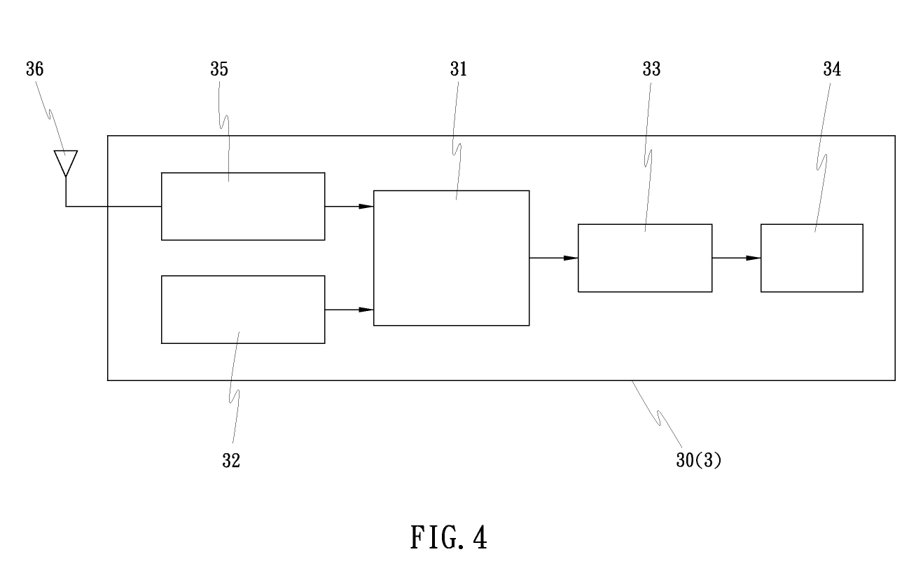

The automatic tissue dispenser 3, as shown in FIG. 4, is controllable to dispense a single tissue 34 at one time. The automatic tissue dispenser 3 may be made in any of a variety of shapes, structures or types, having installed therein a control module 30. The control module 30 comprises a CPU (central processing unit) 31, a mobile sensor 32 and a motor drive 33. By means of the mobile sensor 32, the CPU 31 can be controlled to drive the motor drive 33 to dispense a single tissue 34 at one time. The control module 30 further comprises a RF receiver 35 and a receiving antenna 36. The RF receiver 35 is electrically connected to the CPU 31. The receiving antenna 36 is electrically connected to the RF receiver 35. When the RF receiver 35 receives a RF signal from the automatic soap dispenser 1 through the receiving antenna 36, the CPU 31 drives the motor drive 33 to dispense a single tissue 34.

The automatic soap dispenser 1 and the automatic perfume dispenser 2 and/or the automatic tissue dispenser 3 are combined together, forming a wireless parallel dispensing system installable in a public toilet booth. When a person is using the automatic soap dispenser 1 after the toilet, the automatic soap dispenser 1 transmits a RF signal through the RF transmitter 15 and the transmitting antenna 16 to the automatic perfume dispenser 2 and/or the automatic tissue dispenser 3, causing the automatic perfume dispenser 2 to dispense the perfume 26 for freshening the air and/or the automatic tissue dispenser 3 to dispense one single tissue 34 for the user.

Referring to FIG. 1 again, the automatic soap dispenser 1 transmits a RF signal to drive the automatic perfume dispenser 2 and/or the automatic tissue dispenser 3 each time it is induced to dispense a liquid soap 14. Therefore, the automatic perfume dispenser 2 not only dispenses the perfume 26 periodically according to a pre-set time interval but also increases the number of dispensions with the number of persons using the toilet, thus effectively keeping the air in the toilet fresh. When the number of persons in using the toilet drops below a predetermined level, the automatic perfume dispenser 2 resumes the set frequency in dispensing the perfume 26. Further, the automatic tissue dispenser 3 dispenses tissues 34 according to the number of times the automatic soap dispenser 1 is used, preventing a waste of tissues. Therefore, the wireless parallel dispensing system of the present invention is practical for use in a public toilet booth to automatically dispense liquid soap, perfume and tissues.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wireless parallel dispensing system, comprising an automatic soap dispenser and an automatic perfume dispenser, wherein
said automatic soap dispenser comprises a control module for controlling dispensing of a liquid soap, the control module of said automatic soap dispenser comprising a RF transmitter and a transmitting antenna controllable to transmit a RF signal when the control module of said automatic soap dispenser dispenses said liquid soap; and
said automatic perfume dispenser comprises a control module for controlling dispensing of a perfume, the control module of said automatic perfume dispenser comprising a RF receiver and a receiving antenna adapted for receiving said RF signal and controlling the control module of said automatic perfume dispenser to dispense said perfume upon receiving said RF signal.

2. The wireless parallel dispensing system as claimed in claim 1, wherein the control module of said automatic soap dispenser further comprises a central processing unit, an infrared sensor, and a motor drive.

3. The wireless parallel dispensing system as claimed in claim 1, wherein the control module of said automatic perfume dispenser further comprises a central processing unit, a light sensor, a timer, a duty cycle setter, and a motor drive.

4. A wireless parallel dispensing system, comprising an automatic soap dispenser and an automatic tissue dispenser, wherein
said automatic soap dispenser comprises a control module for controlling dispensing of a liquid soap, the control module of said automatic soap dispenser comprising a RF transmitter and a transmitting antenna controllable to transmit a RF signal when the control module of said automatic soap dispenser dispenses said liquid soap; and
said automatic tissue dispenser comprises a control module for controlling dispensing of one tissue at a time, the control module of said automatic tissue dispenser comprising a RF receiver and a receiving antenna adapted for receiving said RF signal and controlling the control module of said automatic tissue dispenser to dispense one tissue each time said RF receiver and said receiving antenna receives said RF signal.

5. The wireless parallel dispensing system as claimed in claim 4, wherein the control module of said automatic soap dispenser further comprises a central processing unit, an infrared sensor, and a motor drive.

6. The wireless parallel dispensing system as claimed in claim 4, wherein the control module of said automatic tissue dispenser further comprises a central processing unit, a mobile sensor, and a motor drive.
